(19) United States
(12) Patent Application Publication
(10) Pub. No.: US 2023/0356438 A1
(43) Pub. Date: Nov. 9, 2023

(54) SOFT MOLD TOOL INCLUDING A PHOTOMASK

(71) Applicant: VIAVI SOLUTIONS INC, San Jose, CA (US)

(72) Inventors: Riberet ALMEIDA, Rochester, NY (US); Tasso R.M. SALES, Rochester, NY (US); Jaroslaw ZIEBA, Santa Rosa, CA (US); Kangning LIANG, Santa Rosa, CA (US)

(73) Assignee: VIAVI SOLUTIONS INC, San Jose, CA (US)

(21) Appl. No.: 17/737,898

(22) Filed: May 5, 2022

(51) Int. Cl. B29C 33/00; B29C 33/42; B29C 33/40; B29C 33/38

(52) U.S. Cl. CPC B29C 33/405; B29C 33/0011; B29C 33/3892; B29C 33/42; B29C 2033/0005; B29C 2033/0094; B29L 2011/00

(57) ABSTRACT

A soft mold tool including an elastomeric material; and a photomask; wherein the photomask is positioned within the elastomeric material is disclosed. Additionally, a soft mold tool, including an elastomeric material; and an opaque material on a portion of a surface of the elastomeric material is disclosed. A method of making the soft mold tool is also disclosed.

### FIELD OF THE INVENTION

The present disclosure generally relates to a soft mold tool including an elastomeric material; and a photomask, wherein the photomask is positioned within the elastomeric material. An alternative soft mold tool includes an elastomeric material; and an opaque material on a portion of a surface of the elastomeric material. A method of making the disclosed soft mold tools is also disclosed.

### BACKGROUND OF THE INVENTION

There are several benefits associated with making light-shaping optical elements, such as light diffusers and other diffractive optics, in such a way that they incorporate various spatially defined features obtained by implementing a patterning process. This can be relevant to a group of light-shaping optical elements called polymer-on-glass (PoG) diffusers. One example, of such a feature, is separation of the polymer layer forming, the light diffusing element, into discrete regions surrounded by a bare glass region or areas where additional optically or non-optically relevant functions can be realized. The simplest example, of such a non-optical function provided by the bare glass region, is creating glass-only dicing streets around the PoG layer of the optical diffuser. The benefits of implementing this patterning feature is described below:

Light-shaping optical elements such as diffusers, diffractive elements, etc. are often made by applying and properly structuring UV curable polymeric materials on glass substrates. Regardless of the type of UV curable polymeric materials, such as cationic-cure epoxies, free radical cure acrylates or other UV curable systems, it is challenging to make Light-shaping optical elements that can pass high reliability standards imposed an end user. In particular, when the Light-shaping optical elements is made in a wafer format and then subjected to dicing into small single dies with sizes =3x2 mm or smaller, various defects form along the dicing edge and in corners of those dies. During the thermal cycling test, that involves up to a 1,000 -40° C./+85° C. cycles, these defects contribute to delamination of the polymeric material from a glass substrate or to cohesive failure of glass.

What is needed for introducing this spatially variable distribution of the polymeric layer in PoG light diffusers and other PoG light shaping elements is a device, such as a soft mold tool, that can be used with a UV curable polymer in a method of making a die or wafer. The soft mold tool can include a photomask. The disclosed soft mold tool can allow for selective positioning of the UV curable polymer in the method of making a die or wafer.

### BRIEF DESCRIPTION OF THE DRAWINGS

Features of the present disclosure are illustrated by way of example and not limited in the following figure(s), in which like numerals indicate like elements, in which:

FIG. 1A illustrates a cross-section of a soft mold tool including an elastomeric material; and a photomask, according to an aspect of the invention;

FIG. 1B illustrates a cross-section of a soft mold tool including an elastomeric material; and a photomask, according to another aspect of the invention;

FIG. 1C illustrates a cross-section of a soft mold tool including an elastomeric material; and a photomask, according to another aspect of the invention;

FIG. 2A illustrates the soft mold tool of FIG. 1A with a substrate, according to an aspect of the invention;

FIG. 2B illustrates the soft mold tool of FIG. 1B with a substrate, according to another aspect of the invention;

FIG. 2C illustrates the soft mold tool of FIG. 1C with a substrate, according to another aspect of the invention;

FIG. 3 illustrates a method of making a soft mold tool according to an aspect of the invention;

FIG. 4A illustrates a cross-section of a soft mold tool including an elastomeric material; and a photomask, according to another aspect of the invention; and

FIG. 4B illustrates the soft mold tool of FIG. 4A with a substrate, according to an aspect of the invention.

### SUMMARY OF THE INVENTION

In an aspect, there is disclosed a soft mold tool, comprising an elastomeric material; and a photomask; wherein the photomask is positioned within the elastomeric material.

In another aspect, there is disclosed a soft mold too comprising an elastomeric material; and an opaque material on a portion of a surface of the elastomeric material.

In another aspect, there is disclosed a method of making a soft mold tool, comprising patterning a photomask; chemically activating the photomask; applying, onto the activated photomask, a liquid elastomeric material including a polymer and a cross-linking agent; contacting a master having a structured surface with the liquid elastomeric material; curing the elastomeric material; and separating the master from the cured elastomeric material, wherein a surface of the cured elastomeric material mimics the structured surface of the master.

Additional features and advantages of various embodiments will be set forth, in part, in the description that follows, and will, in part, be apparent from the description, or can be learned by the practice of various embodiments. The objectives and other advantages of various embodiments will be realized and attained by means of the elements and combinations particularly pointed out in the description herein.

### DETAILED DESCRIPTION OF THE INVENTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Additionally, the elements depicted in the accompanying figures may include additional components and some of the components described in those figures may be removed and/or modified without departing from scopes of the present disclosure. Further, the elements depicted in the figures may not be drawn to scale and thus, the elements may have sizes and/or configurations that differ from those shown in the figures.

It is to be understood that both the foregoing general description and the following detailed description are exemplary and explanatory only, and are intended to provide an explanation of various embodiments of the present teachings. Additionally, any reference to “top”, “bottom”, “right”, and/or “left” are intended to provide relative physical relationships and is not intended to be limiting.

In its broad and varied embodiments, disclosed herein is a soft mold tool 10, comprising an elastomeric material 14; and a photomask 16; wherein the photomask 16 can be positioned within the elastomeric material 14. In another aspect, a soft mold tool 10 can comprise the elastomeric material 14; and an opaque material on a portion of a surface of the elastomeric material 14. The disclosed soft mold tool including a photomask 16 can be used in a manufacturing process for making a wafer or die. The soft mold tool can allow for curing of the elastomeric material 14 in selected areas, and can mask curing of the elastomeric material 14 in selected areas, such as a dicing street. The soft mold tool 10 can be used for replication.

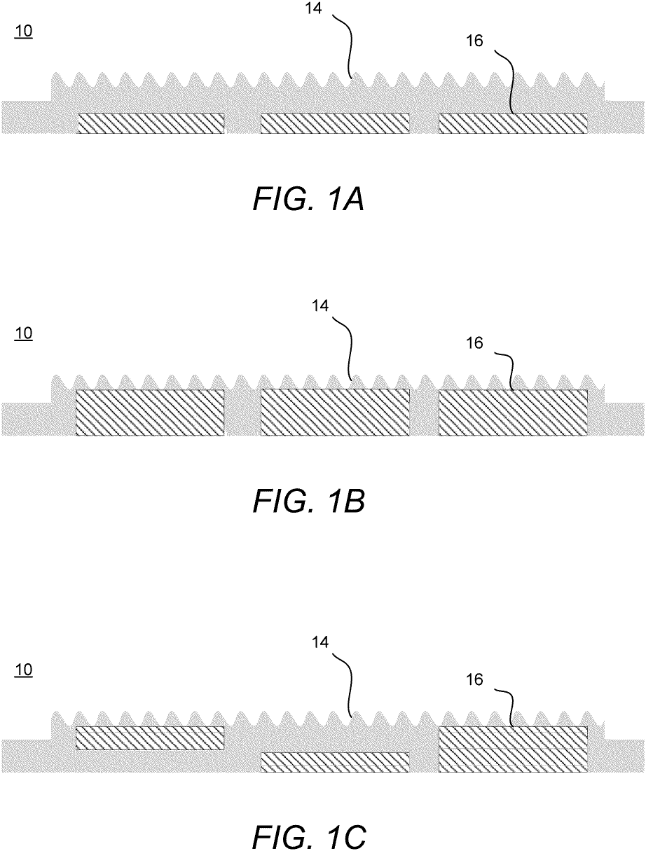

FIGS. 1A-1C illustrates a cross-section of a soft mold tool 10 including an elastomeric material 14; and a photomask 16, in which the photomask 16 can be positioned within the elastomeric material 14. The elastomeric material 14 can be any polymer having a viscosity and an elasticity. The elastomeric material 14 can have a low Young’s modulus, a high yield strength or high failure strain. The elastomeric material 14 can be a thermoplastic elastomer. Furthermore, the elastomeric material 14 can have a wide range of surface energy values ranging from 15 mN/m² to 40 mN/m². Non-limiting examples of a suitable elastomeric material 14 include neoprene (e.g., chloroprene), nitrile (e.g., nitrile-Buna-N, styrene butadiene, carboxylated nitrile, highly saturated nitrile, acrylonitrile butadiene, etc.), styrene butadiene, natural rubber (e.g., polyisoprene, butyl isoprene), ethylene propylene-diene monomer, hypalon (e.g., chlorine-sulfonated polyethylene), silicone rubber, fluoroelastomer (e.g., dipolymers of hexafluoropropylene and vinylidene fluoride, terpolymers, etc.), co-polymer of tetrafluoroethylene and propylene, fluorinated ethylene propylene, urethane, polyurethane (e.g., polyester urethane, polyether urethane, etc.), perfluoroelastomer, fluorosilicone, polyacrylate, fluorinated hydrocarbon, a siloxane-based material (e.g., fluoromethylene polysiloxan, methyl polysiloxan, vinyl methyl polysiloxan, etc.), fluorine rubber, perfluor rubber, ethylene oxide, epichlorohydrin, ethylene acrylate, and combinations thereof. In an aspect, the elastomeric material 14 can include a siloxane-based material. In an aspect, a liquid elastomeric material 14 can include an uncured silicone rubber.

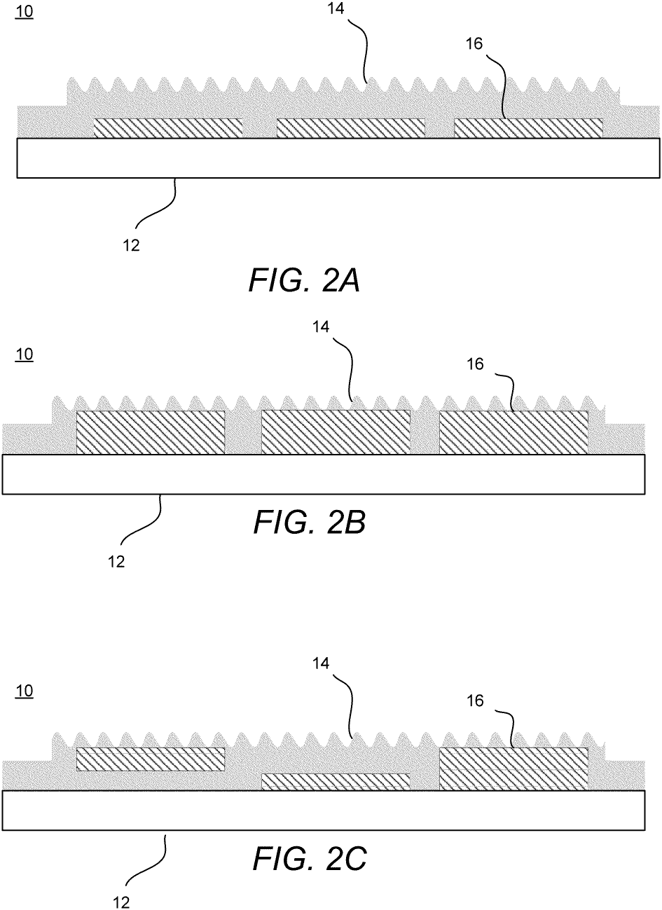

The elastomeric material 14 can be present at a thickness ranging from about 1 micron to about 100 mm, for example, from about 5 microns to about 50 mm, and as a further example, from about 10 microns to about 25 mm. The elastomeric material 14 can be present at any thickness so long as the photomask 16 is present within the thickness of the elastomeric material 14. In this manner, the photomask 16 can be positioned within the elastomeric material 14 so that the photomask 16 does not extend beyond the thickness of the elastomeric material 14, as shown in FIGS. 1A-2C.

The elastomeric material 14 can be in a form of a layer with a first surface that is planar and a second surface, opposite the first surface, that is planar or patterned. The elastomeric material 14 can be present at differing thicknesses along a length of the layer of elastomeric material 14. For example, at a first end and/or at a second end of the layer, the elastomeric material 14 can be present at a first thickness, and in between the first end and the second of the layer, the elastomeric material 14 can be present at a second thickness. The first thickness can be different from the second thickness, for example, the first thickness can be less than a second thickness. Additionally, if a portion of the elastomeric material 14 is patterned, then that patterned portion of the elastomeric material 14 can include differing thicknesses.

The elastomeric material 14 can be present in a composition with a cross-linking agent. Non-limiting examples of a suitable cross-linking agent include organic peroxides, amines, amides, silanes, epoxies, free radical monomers, UV cure monomers, isocyanates, and the like. The cross-linking agent can be present in a composition with the elastomeric material 14 in any amount to assist in cross-linking and/or curing the elastomeric material 14. As will be discussed in more detail herein, the elastomeric material 14 when used in a method of making the soft mold tool 10 can be applied as a liquid, can be partially cured, and can then be fully cured.

The soft mold tool 10 can include a photomask 16, such as one or more photomasks 16. The photomask 16 can be a single photomask with cut-outs or void areas. The photomask 16 can be a plurality of photomasks, as shown in FIGS. 1A-2C. The photomask 16 can have a first surface, such as a bottom surface, that is flush (e.g., forms a continuous plane) with a bottom surface of the elastomeric material 14, as shown in FIGS. 1A-B, and 2A-B. In an aspect, the photomask 16 can have a second surface, such as a top surface, that sits below a top surface of the elastomeric material 14, as shown in FIGS. 1B-C, and 2B-C.

In an aspect, the photomask 16 can be any size or shape so long as it can be positioned within the elastomeric material 14 and can enable selective curing of select areas of the elastomeric material 14. For example, the photomask 16 can have a thickness that equals a thickness of the elastomeric material 14, a thickness that can be substantially the same (e.g., ≥ 50% and < 100%) thickness as the elastomeric material 14, or a thickness that can be substantially different (e.g., > 0% and <50%) of the thickness of the elastomeric material 14.

The soft mold tool 10 can include a plurality of photomasks 16 in which each photomask 16, of the plurality of photomasks 16, can be a different size and shape, and can be positioned in a different location within the elastomeric material 14 In this manner, the photomask 16 can be used to form a design or pattern. In an aspect, the pattern imprinted in the photomask 16 can be a non-rectangular shape. The pattern present in the photomask 16 can allow for replication of light-shaping optical elements with shapes that are not rectangular. The photomask 16 can be positioned within the elastomeric material 14 in a manner to enable curing of selected areas of the elastomeric material 14.

The photomask 16 can be a binary photomask including an opaque area and a transparent area. The opaque area can be full absorbing and can include an absorbing material. The transparent area can be non-absorbing and can be void of (or absent) an absorbing material. The inclusion of an opaque area and a transparent area can form a patterned surface on the photomask 16.

The soft mold tool 10 can include a photomask 16 in which the opaque area of the photomask 16 can be an anti-reflective film. The anti-reflective film can include a layer of absorbing material. The absorbing material can include both selective absorbing materials and nonselective absorbing materials. For example, the layer of absorbing material can be formed of nonselective absorbing metallic materials deposited to a thickness at which the absorber layer is at least partially absorbing, or semi-opaque. An example of a non-selective absorbing material can be a gray metal, such as chrome or nickel. An example of a selective absorbing material can be copper or gold. In an aspect, the absorbing material can be chromium. Non-limiting examples of suitable absorber materials include metallic absorbers such as chromium, aluminum, silver, nickel, palladium, platinum, titanium, vanadium, cobalt, iron, tin, tungsten, molybdenum, rhodium, niobium, carbon, graphite, silicon, geranium, cermet and various combinations, mixtures, compounds, or alloys of the above absorber materials that may be used to form the absorber layer. In another aspect, the layer of absorbing material can be a layer of chromium oxide.

Examples of suitable alloys of the above absorber materials can include Inconel (Ni-Cr-Fe), stainless steels, Hastalloys (Ni-Mo-Fe; Ni-Mo-Fe-Cr; Ni-Si-Cu) and titanium-based alloys, such as titanium mixed with carbon (Ti/C), titanium mixed with tungsten (Ti/W), titanium mixed with niobium (Ti/Nb), and titanium mixed with silicon (Ti/Si), and combinations thereof. Other examples of suitable compounds for the absorber layer include titanium-based compounds such as titanium silicide (TiSi₂), titanium boride (TiB₂), and combinations thereof. Alternatively, the absorber layer can be composed of a titanium-based alloy disposed in a matrix of Ti, or can be composed of Ti disposed in a matrix of a titanium-based alloy.

As discussed herein, the photomask 16 can include a transparent area. In an aspect, the transparent area can be an area void of the absorbing material. For example, if the opaque area is an anti-reflective film, the transparent area can be an area in which the anti-reflective film has been removed, such as by etching.

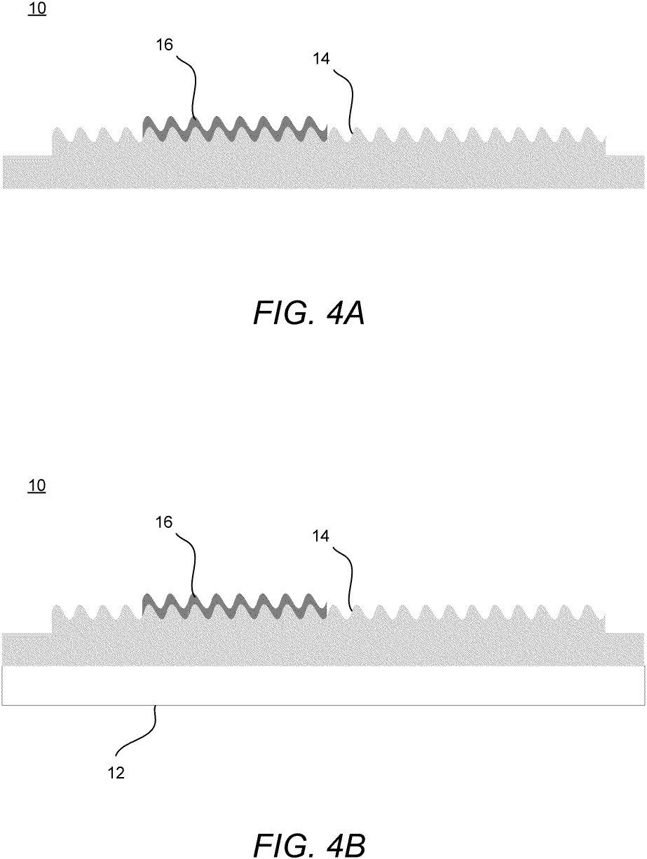

The soft mold tool 10 can further include a substrate 12. The substrate 12 can be any material that can receive one or more layers. In an aspect, as shown in FIGS. 2A and 2B, one or more photomasks 16 can be present on portions of a surface of the substrate 12. The elastomeric material 14 can be present on portions of a surface of the substrate 12. In this manner, an entire surface of the substrate 12 can interface with the elastomeric material 14 and/or one or more photomasks 16. In another aspect, as shown in FIGS. 4A and 4B, the surface of the substrate 12 interfaces with the elastomeric material 14 and does not interface with one or more photomasks 16.

In an aspect, the substrate 12 can be a transparent material. Non-limiting examples of suitable substrate materials include glass, fused silica, soda lime and polymers, such as polycarbonate, polymethylmethacrylate, polyethylene terephthalate, polyethylene, amorphous copolyester, polyvinyl chloride; liquid silicon rubber, cyclic olefin copolymers, ionomer resin, transparent polypropylene, fluorinated ethylene propylene, styrene methyl methacrylate, styrene acrylonitrile resin, polystyrene, and methyl methacrylate acrylonitrile butadiene styrene. In an aspect, the substrate 12 can be a clear material including fused silica, soda lime, and combinations thereof.

The substrate 12 can be present at a thickness ranging from about 0.05 mm to about 6.35 mm, for example, from about 0.1 mm to about 5 mm, and, as a further example, from about 0.15 mm to about 1.0 mm.

FIG. 1A illustrates a soft mold tool 10 including an elastomeric material 14 having a planar bottom surface, a first end with a first thickness, a second end with a second thickness, and a portion between the first end and the second end with a third thickness. The first and second thickness can be the same. The portion between the first end and the second end includes a patterned top surface with a variable thickness relative to the pattern. The soft mold tool 10 also includes three photomasks 16 that are positioned within the elastomeric material 14 and are flush with a bottom planar surface. The photomasks 16 are the same size and shape. FIG. 2A illustrates the soft mold tool of FIG. 1A also including a substrate 12.

FIG. 1B illustrates another soft mold tool 10, which is similar to FIG. 1A, with the exception of the photomask 16. The photomask 16 is three photomasks having the same size and shape. The photomask 16 has a thickness substantially the same as a thickness of the elastomeric material 14 in the portion between the first end and the second end. FIG. 2B illustrates the soft mold tool of FIG. 1B also including a substrate 12.

FIG. 1C illustrates another soft mold tool 10, which is similar to FIGS. 1A and 1B, with the exception of the photomask 16. The photomask 16 is three photomasks having different sizes and shapes and positioned in different locations within the elastomeric material 14. For example, the left photomask 16 is rectangular shaped and is located just beneath the plane of the patterned top surface of the elastomeric material 14. The center photomask 16 is also rectangular shaped is positioned flush with a bottom planar surface of the elastomeric material 14. The right photomask 16 is a different size from the left and center photomask and has a thickness that is substantially the same as the elastomeric material 14. FIG. 2C illustrates the soft mold tool of FIG. 1C also including a substrate 12.

In another aspect, as shown in FIG. 4A, there is disclosed a soft mold tool 10, including an elastomeric material 14; and a photomask 16 on a portion of a surface of the elastomeric material 14. The elastomeric material 14 and the photomask 16 can be as described herein. The photomask 16 can be an opaque material, such as an absorbing material, and can conform to a top surface of the elastomeric material 14. For example, if the top surface of the elastomeric material 14 is planar, then the photomask 16 can form a conforming layer on the top surface. If the top surface of the elastomeric material 14 is patterned, such as diffracted, then the photomask 16 can form a conforming layer on the patterned top surface. The photomask 16 can interface with a portion, but less than the entire portion, of the top surface of the elastomeric material 14. More than one photomask 16 can be present on the top surface of the elastomeric material 14. As shown in FIG. 4B, the soft mold tool 10 can also include a substrate 12. The substrate 12 can be as described herein. The elastomeric material 14 is on a surface of (e.g., interfaces with) the substrate 12.

There is also disclosed a method of making a soft mold tool, comprising patterning a photomask 16 and a substrate 12; chemically activating the photomask 16; applying, onto the activated photomask 16, a composition including a liquid elastomeric material 14 and a cross-linking agent; contacting a master 18 having a structured surface 20 with the liquid elastomeric material 14; curing the liquid elastomeric material 14; and separating the master 18 from the cured elastomeric material 14; wherein a surface of the cured elastomeric material 14 mimics the structured surface 20 of the master 18. The method also includes before curing the liquid elastomeric material 14, chemically activating a surface of the photomask 16. The photomask 16 can covalently bond with the cured elastomeric material 14.

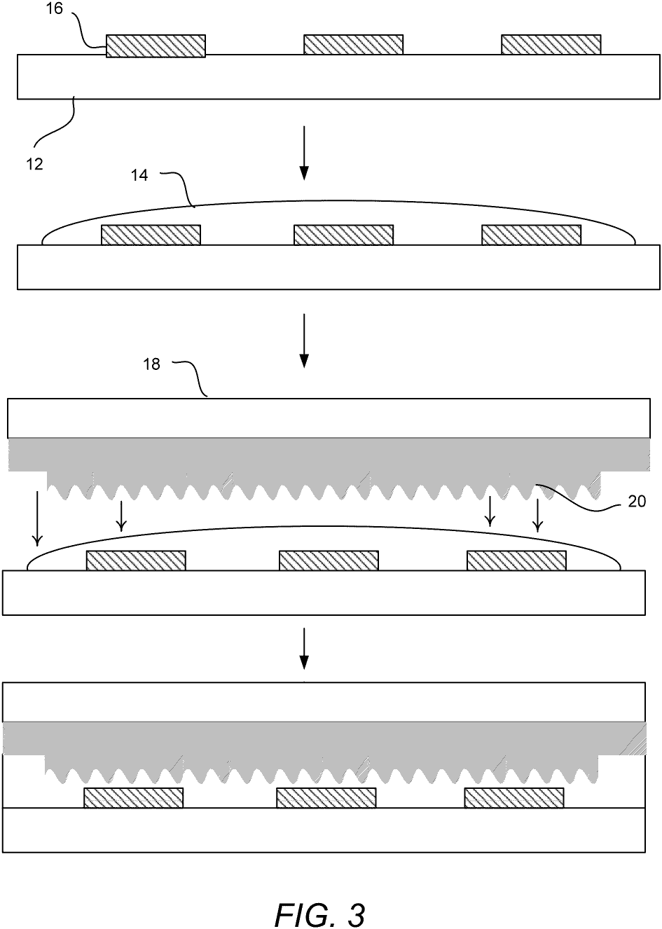

FIG. 3 is a flow chart of the method. The first line of the flow chart depicts patterning a photomask 16 and a substrate 12. In particular, an absorbing material, such as chrome, can be patterned onto the substrate 12. For example, three separate photomasks 16 can be patterned onto the substrate 12. The film of opaque material for creating the photomask 16 can be deposited on the substrate 12 by either a chemical or PVD coating process. Once deposited, the opaque material can be patterned using an appropriate method, such as e-beam mask writing and then etched and cleaned.

The photomask 16 can be chemically activated by application of a vapor primer to a surface of the substrate 12 and the photomask 16. The vapor primer can be applied be applied by direct vacuum evaporation of a low molecular weight adhesion promoter or coupling agent molecules. The vapor primer can enable the application and/or adherence of the liquid elastomeric material 14.

The second line of FIG. 3 illustrates application of a liquid elastomeric material 14 onto the chemically activated photomask 16 and substrate 12. The liquid elastomeric material 14 can be present in a composition including a cross-linking agent. In an aspect, the liquid elastomeric material 14 can include an uncured silicone rubber.

The third and fourth lines of FIG. 3 illustrate contacting a master 18 having a structured surface 20 with the liquid elastomeric material 14. The master 18 can be a mirror-imaged template of the soft mold tool 10. The structured surface 20 can be a patterned or diffractive surface. The master 18 can be contacted with the liquid elastomeric material 14 for a sufficient period of time and at a sufficient pressure for the liquid elastomeric material 14 to conform to the structured surface 20 of the master 18.

The liquid elastomeric material 14 can be allowed to cure using conventional processes. For example, a collimated or diffused ultraviolet light source can be used to emit light on the liquid elastomeric material 14. Once the liquid elastomeric material 14 has cured so that the structured surface 20 of the master 18 has been replicated in the top surface of the elastomeric material 14, the master 18 can be separated from the cured elastomeric material 14.

An example of this method is represented by the use of platinum addition cured silicone as a liquid elastomeric material 14 that can be poured over the photomask 16 and then contacted with a master 18 made with fused silica or another properly structured material. After the mechanical contact between the liquid silicone elastomer 14 and the master 18 is established, a precisely measured pressure can be applied to the master 18 to allow the liquid elastomeric material 14 to reach a desired thickness. The liquid elastomeric material 14 undergoes a curing step that solidifies it to a point at which it is feasible to separate it cleanly from a surface of the master 18. After the photomask 16 incorporating structured elastomeric material 14 was removed from the master 18 to form a soft mold tool 10, the soft mold tool 10 undergoes a final hardening process to adjust its final mechanical and chemical properties before it can be used as a soft mold tool 10.

There is also disclosed a method for making the soft mold tool 10 shown in FIGS. 4A-4B. The soft mold tool 10 formed by the method can include high fidelity microstructures. The method can include dispensing, onto a master 18 having a structured surface 20, a liquid elastomeric material 14 and a cross-linking agent; partially curing the liquid elastomeric material 14; placing a photomask 16 onto a portion of a surface of the partially cured elastomeric material 14; fully curing the partially cured elastomeric material 14 and the photomask 16; and separating the master 18 from the photomask 16 bonded with the cured elastomeric material 14; wherein the cured elastomeric material 14 and the photomask 16 mimics the structured surface 20 of the master 18.

The liquid elastomeric material 14 and the cross-linking agent can be subjected to conventional curing processes and allowed to partially cure. By partially cure it is intended to mean that the elastomeric material 14 can retain the physical dimensions of the structured surface 20 of the master 18, but is not fully cured to hardening. The degree of the partial cure can be obtained my measuring a Shore A hardness of the elastomeric material or a “tackiness” of its surface. In some aspects, a partial cure can be determined by either the disappearance of certain chemical bonds or formation of new types of bonds by means of IR (FTIR) spectroscopy.

From the foregoing description, those skilled in the art can appreciate that the present teachings can be implemented in a variety of forms. Therefore, while these teachings have been described in connection with particular embodiments and examples thereof, the true scope of the present teachings should not be so limited. Various changes and modifications can be made without departing from the scope of the teachings herein.

The scope of this disclosure is to be broadly construed. It is intended that this disclosure disclose equivalents, means, systems and methods to achieve the devices, activities and mechanical actions disclosed herein. For each device, article, method, mean, mechanical element or mechanism disclosed, it is intended that this disclosure also encompass in its disclosure and teaches equivalents, means, systems and methods for practicing the many aspects, mechanisms and devices disclosed herein. The claims of this application are likewise to be broadly construed. The description of the inventions herein in their many embodiments is merely exemplary in nature and, thus, variations that do not depart from the gist of the invention are intended to be within the scope of the invention. Such variations are not to be regarded as a departure from the spirit and scope of the invention.

What is claimed is:

1. A soft mold tool, comprising:
an elastomeric material; and
a photomask;
wherein the photomask is positioned within the elastomeric material.

2. The soft mold tool of claim 1, wherein the elastomeric material is in a form of a layer with a first surface that is planar, and a second surface, opposite the first surface, that is planar or patterned.

3. The soft mold tool of claim 1, wherein the elastomeric material includes a siloxane-based material.

4. The soft mold tool of claim 1, wherein the elastomeric material has a thickness ranging from about 1 micron to about 100 mm.

5. The soft mold tool of claim 1, wherein the photomask has a bottom surface that is flush with a bottom surface of the elastomeric material.

6. The soft mold tool of claim 1, wherein the photomask has a thickness that is substantially the same as a thickness of the elastomeric material.

7. The soft mold tool of claim 1, wherein the photomask is a plurality of photomasks, and wherein each photomask, in the plurality of photomasks is configured in a different size, a different shape, and/or a different location within the elastomeric material to form a pattern or design.

8. The soft tool of claim 7, wherein the pattern imprinted in the photomask is not rectangular.

9. The soft mold tool of claim 1, wherein the photomask is a binary photomask including an opaque area and a transparent area.

10. The soft mold tool of claim 9, wherein the opaque area of the photomask includes an anti-reflective film.

11. The soft mold tool of claim 10, wherein the anti-reflective film includes a layer of an absorbing material.

12. The soft mold tool of claim 9, wherein the transparent area of the photomask is an area void of an absorbing material.

13. The soft mold tool of claim 1, further comprising a substrate.

14. The soft mold tool of claim 13, wherein the substrate is a clear material including fused silica, soda lime, and combinations thereof.

15. A soft mold tool, comprising:
an elastomeric material; and
a photomask on a portion of a surface of the elastomeric material.

16. The soft mold tool of claim 15, further comprising a substrate, wherein the elastomeric material is on a surface of the substrate.

17. A method of making a soft mold tool of claim 1, comprising:
patterning a photomask and a substrate;
chemically activating the photomask;
applying, onto the activated photomask, a composition including a liquid elastomeric material and a cross-linking agent;
contacting a master having a structured surface with the liquid elastomeric material;
curing the elastomeric material; and
separating the master from the cured elastomeric material;
wherein a surface of the cured elastomeric material mimics the structured surface of the master.

18. The method of claim 17, further comprising, before curing the liquid elastomeric material, chemically activating a surface of the photomask.

19. The method of claim 17, wherein the photomask is covalently bonded with the cured elastomeric material.

20. A method of making a soft mold tool of claim 15, comprising:
dispensing, onto a master having a structured surface, a liquid elastomeric material and a cross-linking agent;
partially curing the liquid elastomeric material;
placing a photomask onto a portion of a surface of the partially cured elastomeric material;
fully curing the partially cured elastomeric material and the photomask 16; and
separating the master from the photomask bonded with the cured elastomeric material;
wherein the cured elastomeric material and the photomask mimics the structured surface of the master.
